(19) United States
(12) Patent Application Publication
(10) Pub. No.: US 2007/0146400 A1
(43) Pub. Date: Jun. 28, 2007

(54) Inkjet apparatus and inkjet method for ink deposition with improved precision

(75) Inventors: Jin-koo Chung, Gyeonggi-do (KR); Dong-won Lee, Gyeonggi-do (KR); Jung-soo Rhee, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/645,298

(22) Filed: Dec. 22, 2006

(30) Foreign Application Priority Data
Dec. 23, 2005 (KR) 10-2005-0128958

(51) Int. Cl. B41J 29/38

(52) U.S. Cl. 347/9

(57) ABSTRACT

The present invention relates to an inkjet apparatus and an inkjet method that allows a more precise control over ink deposition. The inkjet apparatus includes: a stage having a seating zone for supporting a substrate, a jetting zone, and an exclusion zone; a nozzle head having at least one nozzle directed at the stage; an ink feeder supplying ink to the nozzle head; a driver driving at least one of the nozzle head and the stage to move the nozzle head and the stage relative to each other; and a controller controlling the ink feeder to supply ink to nozzle head when the nozzle head is placed in the jetting zone and to stop the ink supply to the nozzle head when the nozzle head is placed in the exclusion zone. Accordingly, according to the present invention, there is provided an inkjet apparatus which can reduce an ink blur and an inkjet method which can reduce an ink blur.

### CROSS-REFERENCE TO RELATED APPLICATIONS

This application claims the benefit of Korean Patent Application No. 2005-0128958 filed on Dec. 23, 2005 in the Korean Intellectual Property Office, the disclosure of which is incorporated herein by reference.

### BACKGROUND OF THE INVENTION

1. Field of the Invention

The present invention relates to an inkjet apparatus and an inkjet method, and more particularly to an inkjet apparatus and an inkjet method that uses an exclusion zone to decrease ink deposition outside the intended surface.

2. Description of the Related Art

A flat panel display such as a liquid crystal display (LCD), an organic light emitting diode (OLED), etc. has recently been widely used as an improved alternative to a conventional cathode ray tube (CRT).

A flat panel display includes various organic layers such as a color filter layer, an organic semiconductor layer, an emission layer, an alignment layer, etc. Recently, inkjet method has been widely used for forming these organic layers. Advantageously, the inkjet method allows the organic layer to be patterned without exposure, development, etching, etc., thus using less organic material than with some other conventional methods such as photolithography and etching.

Meanwhile, when the substrate is large, a plurality of nozzle heads are used to reduce processing time. The plurality of nozzle heads, which are mounted to a head body, moves together with the head body. Further, each nozzle head includes a plurality of nozzles.

However, when the plurality of nozzle heads is employed, some nozzle heads are placed outside the desired deposition area on the substrate during the jetting process. As a result, ink is jetted out from the nozzle heads to an area outside the intended area. This results in undesirable deposition of ink on a part of the apparatus that is not meant to receive ink. As such deposition of ink on unintended areas degrades display quality, a method of depositing ink by inkjetting without the extraneous deposition is desired.

### SUMMARY OF THE INVENTION

Accordingly, it is an aspect of the present invention to provide an inkjet apparatus that allows a more precise control over ink deposition boundary. Another aspect of the present invention is to provide an inkjet method that allows a more precise control over ink deposition boundary.

Additional aspects and/or advantages of the present invention will be set forth in part in the description which follows and, in part, will be obvious from the description, or may be learned by practice of the present invention.

In one aspect, the invention is an inkjet apparatus including: a stage having a seating zone for supporting a substrate, a jetting zone, and an exclusion zone; a nozzle head having a nozzle directed toward the stage; an ink feeder supplying ink to the nozzle head; a driver driving at least one of the nozzle head and the stage to move the nozzle head and the stage relative to each other; and a controller controlling the ink feeder to supply ink to the nozzle head when the nozzle head is placed in the jetting zone and to stop the ink supply to the nozzle head when the nozzle head is placed in the exclusion zone.

In another aspect, the present invention is an inkjet method that entails: providing a substrate on a stage that has a seating zone, a jetting zone, and an exclusion zone; jetting ink while a nozzle head having a nozzle and the stage are moved relatively to each other; and stopping the nozzle head from jetting the ink when the nozzle head is placed in an exclusion zone.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a perspective view of an inkjet apparatus according to a first embodiment of the present invention;

FIGS. 2A and 2B illustrate a nozzle head of the inkjet apparatus according to the first embodiment of the present invention;

FIG. 3 is a control block diagram of the inkjet apparatus according to the first embodiment of the present invention;

FIG. 4 is a plan view of the inkjet apparatus with a substrate according to the first embodiment of the resent invention;

FIG. 5 is an equivalent circuit diagram of a pixel in a display apparatus manufactured according to the present invention;

FIG. 6 is a sectional view of the display apparatus according to the present invention;

FIG. 7 is a flowchart of an inkjet method according to the present invention;

FIGS. 8, 9A, 9B, 9C, 10A, 10B, 11A, 11B, 12A and 12B illustrate a method of manufacturing the display apparatus according to the present invention; and

FIGS. 13 through 15 illustrate inkjet apparatuses according to second through fourth embodiments of the present invention, respectively.

### DETAILED DESCRIPTION OF EMBODIMENTS

Hereinafter, embodiments of the present invention will be described with reference to accompanying drawings, wherein like numerals refer to like elements and repetitive descriptions will be avoided as necessary.

Hereinafter, a first layer being “on” or “above” a second layer includes both the case where a third layer (e.g., a film) is interposed between the first and second layers and the case where the first and second layers (i.e., films) are in contact with each other.

As used herein, “ink” may be any liquid capable of being inkjetted, including but not limited to a hole injecting material in a solvent.

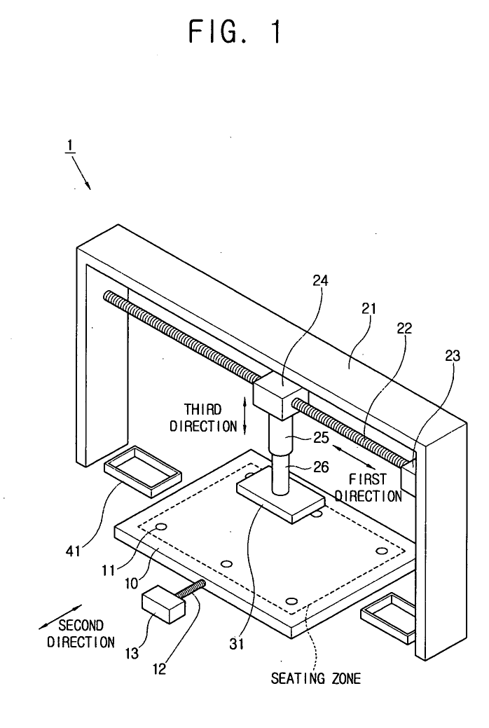

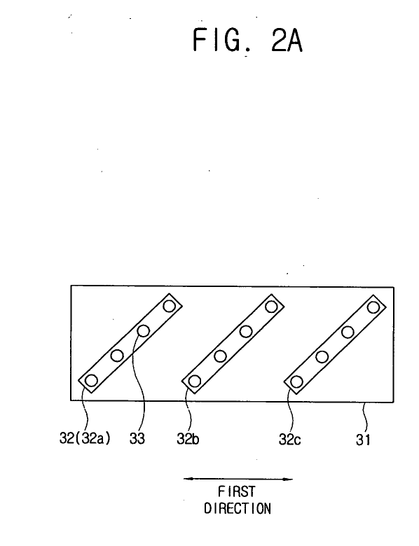

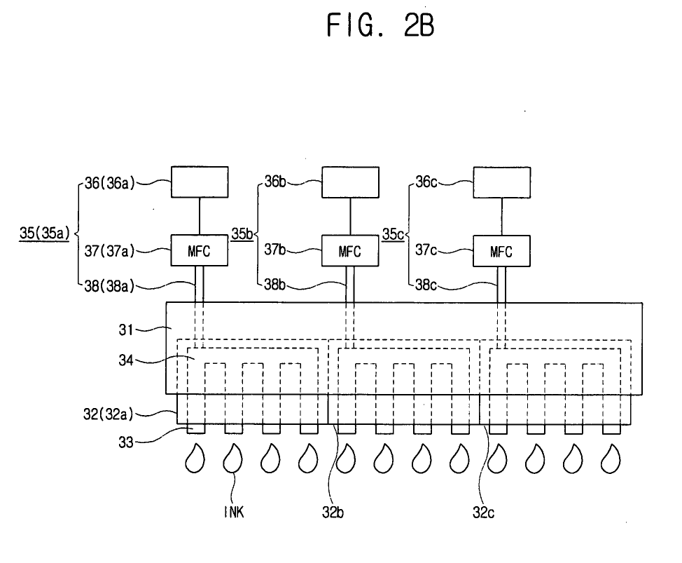

Referring to FIG. 1, 2A, and 2B, an inkjet apparatus according to a first embodiment of the present invention will now be described. FIG. 1 is a perspective view of the inkjet apparatus according to the first embodiment of the present invention, and FIGS. 2A and 2B illustrate a nozzle head of the inkjet apparatus according to the first embodiment of the present invention.

An inkjet apparatus 1 includes a stage 10 on which a substrate is seated; a nozzle head 32 placed on the stage 10 and provided with a nozzle 33 through which ink jets out; and a pair of ink-receivers 41 disposed off the stage 10.

The nozzle head 32 and the stage 10 can move along first and second directions perpendicularly to each other, respectively. More specifically, the inkjet apparatus 1 includes a first driver 23 connected to the nozzle head 32 and driving the nozzle head 32 to move in the first direction, and a second driver 13 connected to the stage 10 and driving the stage 10 to move in the second direction.

The stage 10 is shaped approximately like a rectangle and functions as a platform that supports an object, like a substrate, on which an organic layer will be inkjetted. Further, the stage 10 includes a vacuum chuck 11 to hold the substrate in place, although the vacuum chuck 11 may be replaced with another holding means that is capable of serving a similar function. For example, an electrostatic chuck can be used to hold the substrate in place.

The stage 10 is connected to the second driver 13 by a second screw 12. The second screw 12 rotates clockwise or counterclockwise by operation of the second driver 23, and thus the stage 10 moves in the second direction parallel with a short side of the stage 10. Here, the second driver 13 may include a motor.

In some embodiments, the inkjet apparatus 1 can include a rail (not shown) to facilitate the movement of the stage 10.

The stage 10 is partly surrounded by a supporting body 21. The supporting body 21 is approximately shaped like a reverse-U (∩), and supports a head body 31. On the surface of the head body 31 that is facing the stage 10, there is one or more nozzle heads 32. The supporting body 21 forms a bridge over the stage 10 by extending over the stage 10 in the first direction.

The supporting body 21 is provided with a first screw 22. The first screw 22 has a first end rotatably connected to a first side of the supporting body 21, and a second end connected to the first driver 23 fastened to a second side of the supporting body 21. The first screw 22 is screw-coupled with a rotation-shaft connector 24 that is female-threaded. The rotation-shaft connector 24 reciprocates in the first direction according to rotating directions of the first screw 22.

As the rotation-shaft connector 24 operates, the head body 31 connected to the rotation-shaft connector 24 moves. Here, the first screw 22 extends in the first direction, so that the head body 31 moves perpendicularly to the stage 10.

The head body 31 is connected to the rotation-shaft connector 24 through a third driver 25 and a medium connector 26. The third driver 25 is retractable, so that the head body 31 can move in a third direction orthogonal to a surface of the stage 10. Therefore, the head body 31 can move closer to or farther away from the stage 10.

The foregoing configuration is described as an exemplary way of achieving the intended movement of the stage 10 relative to the head body 31. Thus, the configuration may vary as long as the movement of the stage 10 relative to the head body 31 is achieved.

Referring to FIGS. 2A and 2B, the nozzle head 32 will be described in more detail. FIG. 2B shows what would be the underside of the head body 31 in reference to FIG. 1.

The head body 31 has a rectangular shape. The nozzle head 32 includes three sub nozzle heads 32a, 32b and 32c. The sub nozzle heads are mounted on the head body 31 along the first direction. Each nozzle head 32 is disposed at a predetermined angle with respect to an edge of the rectangular head body 31, and this angle is determined according to intervals between inkjet objects.

In the embodiment shown, each nozzle head 32 ahs four nozzles 33 mounted in a row. Each nozzle head 32 receives ink from a separate ink feeder 35. The ink feeder 35 includes an ink tank 36 that holds the ink; a mass flow controller 37 to adjust an ink flux; and a channel pipe 38 connecting the ink tank 36 to the head body 31. The ink feeder 35 includes three sub ink feeders 35a, 35b and 35c. The sub ink feeders 35a, 35b and 35c individually supply the sub nozzle heads 32a, 32b and 32c connected thereto, respectively. Further, the ink tank 36, the mass flow controller 37 and the channel pipe 38 include three sub ink tanks 36a, 36b and 36c, three sub mass flow controller 37a, 37b and 37c, and three sub channel pipes 38a, 38b and 38c, respectively.

The sub ink feeders 35a, 35b and 35c may supply different inks or the same ink.

The ink fed to the head body 31 through the channel pipe 38 is supplied to the nozzle 33 through a channel 34 provided in the head body 31 and the nozzle head 32, and then jetted out.

Referring back to FIG. 1, the pair of ink-receivers 41 is provided off the stage 10. The ink-receivers 41 are shaped with reservoirs to receive the jetted ink, but the specific shape of the ink-receivers 41 is not a limitation of the invention. In some embodiments, the ink-receivers 41 may be a piece of cloth capable of absorbing the jetted ink. When the ink does not jet out from the nozzle 33, the nozzle 33 is likely to be clogged or deteriorated in performance. Therefore, during a jetting standby time, for example, when the substrate is replaced by a new one, the head body 31 moves above the ink receiver 41 and jets the ink to the ink receiver 41.

The ink-receiver 41 is placed under the first screw 22. Thus, the head body 31 moves in the first direction along the first screw 22 and is disposed above the ink-receiver 41.

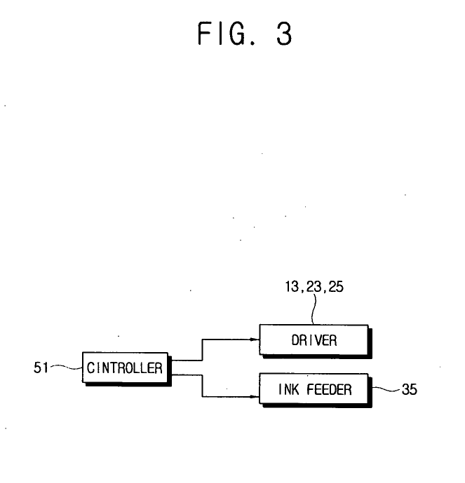

FIG. 3 is a control block diagram of the inkjet apparatus according to the first embodiment of the present invention. A controller 51 controls each of the drivers 13, 23 and 25 to adjust the relative positions of the stage 10 and the head body 31 or place the head body 31 above the ink-receiver 41. Further, the controller 51 controls the ink feeder 35, thereby making the ink jet out through the nozzle 33 or stopping the ink from jetting out. The controller 51 can individually control the sub ink feeders 35a, 35b and 35c, so that it is possible to selectively make some nozzle heads 32 jet out the ink but not others.

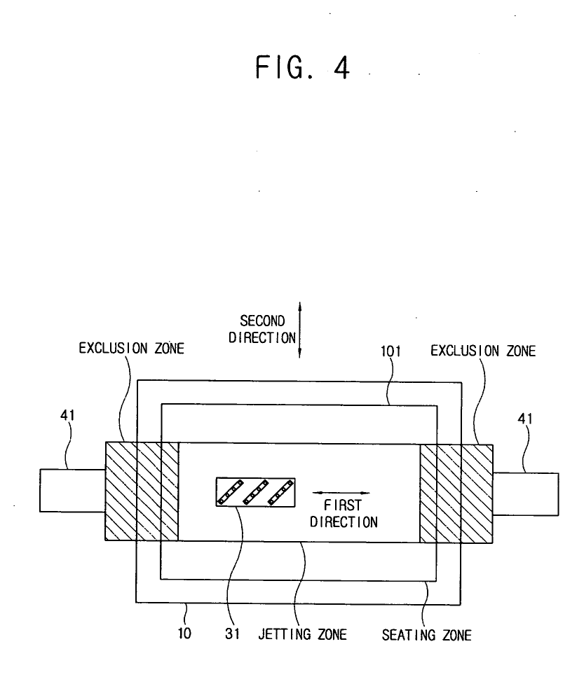

FIG. 4 is a plan view of the inkjet apparatus with a substrate according to the first embodiment of the resent invention. As shown, the stage 10 has a seating zone, a jetting zone, and an exclusion zone. The seating zone is extends outside the exclusion zone. The seating zone is substantially all of the stage 10 except the edges.

A substrate 101 is placed in the seating zone, and jets ink in the jetting zone. Here, the substrate 101 may be a substrate for a display apparatus such as an organic electroluminescent display (OLED), a liquid crystal display (LCD) or the like. An organic semiconductor layer, an emission layer, a color filter layer, an alignment layer, etc may be formed on the substrate 101. If the substrate 101 is used in the display apparatus, the jetting zone is approximately equal to a display zone.

The exclusion zone is provided outside the jetting zone. The exclusion zone extends along the second direction, and is located on two ends of the jetting zone. More specifically, the exclusion zone is disposed between the jetting zones and the ink-receiver 41.

Now, the controller 51 of FIG. 3 will be described in more detail in reference to the exclusion zone of FIG. 4.

The controller 51 controls the ink feeder 35 so that the ink feeder 35 does not supply the ink to the nozzle head 32 that is placed above the exclusion zone. Thus, even though some of the nozzle heads 32 are placed between the ink-receiver 41 and the jetting zone, no ink jets out out from these nozzle heads 32. This way, any blurring of the ink from its deposition outside the jetting zone is reduced or even eliminated.

When a certain nozzle 33 stays in the exclusion zone without jetting out the ink therethrough for long time, the nozzle 33 is likely to clog. In this case, maintenance is performed to maintain the performance of the nozzle 33. To avoid clogging, according to the first embodiment, the controller 51 controls the driver 23 to place the certain nozzle head 32 above the ink-receiver 41 when the certain nozzle head 32 stays in the exclusion zone beyond a predetermined period of time. At the same time, the controller 51 controls the ink feeder 35 to make the nozzle head 32 placed above the ink-receiver 41 to jet out the ink. This way, any blurring is avoided because there is still no ink deposited in the exclusion zone. At the same time, clogging of the nozzle 33 is avoided as well. The period of time for before the maintenance can be determined according to the kinds of ink, the concentration of solid powder, and the shape of the nozzle 33.

According to the first embodiment, no ink is jetted between the ink-receiver 41 and the jetting zone, so that ink blur is decreased and the high performance level of the nozzle 33 is maintained.

Various adjustments may be made to the first embodiment without depart from the scope of the invention. For example, the ink feeder 35 can include a valve provided between the ink tank 36 and the head body 31. In this case, the controller 51 closes the valve that is connected to the particular the nozzle head 32 placed within the exclusion zone.

In some embodiments, the ink feeder 35 can include a pressure-adjustable ink tank. In this case, ink can be jet through the nozzle 33 by adjusting the pressure of the ink tank. At this time, the controller 51 controls the ink feeder 35 to reduce the pressure of the particular ink tank that is connected to the nozzle head 32 placed in the exclusion zone.

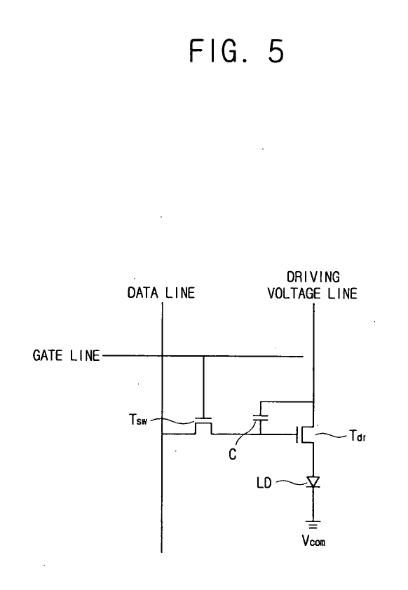

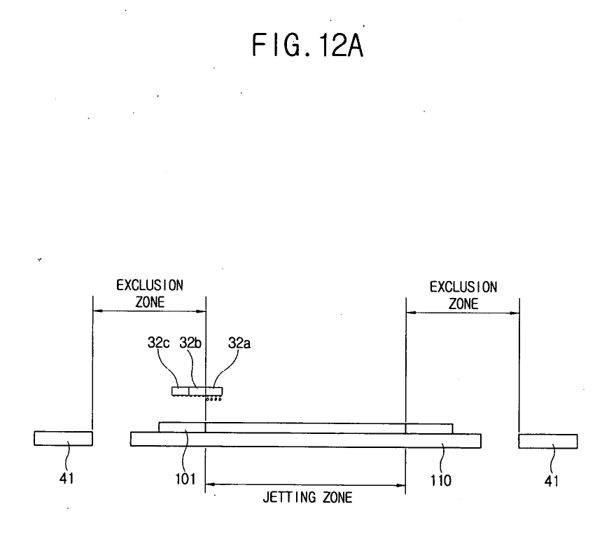

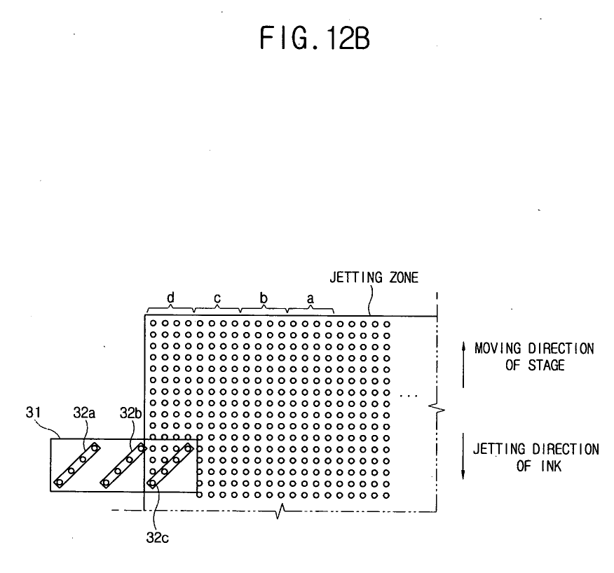

Below, a method of manufacturing a display apparatus by the inkjet apparatus according to the first embodiment will be described with reference to FIGS. 5 through 12B. Although an organic electroluminescent display will be described as an example of the display apparatus, this is not a limitation of the invention.

FIG. 5 is an equivalent circuit diagram of a pixel in a display apparatus manufactured according to the present invention.

One pixel includes a plurality of signal lines. The signal lines include a gate line to transmit a scan signal, a data line to transmit a data signal, and a driving voltage line to apply a driving voltage. The data line and the driving voltage line are arranged parallel to each other. Further, the gate line extends perpendicularly to both the data line and the driving voltage line.

Each pixel includes an organic light emitting device LD, a switching thin film transistor Tsw, a driving thin film transistor Tdr, and a capacitor C.

The driving thin film transistor Tdr has a control terminal connected to the switching thin film transistor Tsw, an input terminal connected to the driving voltage line, and an output terminal connected to the organic light emitting device LD.

The organic light emitting device LD has an anode connected to the output terminal of the driving thin film transistor Tdr, and a cathode connected to a common voltage Vcom. The organic light emitting device LD emits light with brightness varying according to the intensity of a current outputted from the driving thin film transistor Tdr, thereby displaying an image. Here, the intensity of the current outputted from the driving thin film transistor Tdr varies according to voltages applied between the control terminal and the output terminal of the driving thin film transistor Tdr.

The switching thin film transistor Tsw has a control terminal connected to the gate line, an input terminal connected to the data line, and an output terminal connected to the control terminal of the driving thin film transistor Tdr. The switching thin film transistor Tsw transmits the data signal from the data line to the driving thin film transistor Tdr in response to the scan signal applied to the gate line.

The capacitor C is connected between the control terminal and the input terminal of the driving thin film transistor Tdr. The capacitor C stores and maintains the data signal to be inputted to the control terminal of the driving thin film transistor Tdr.

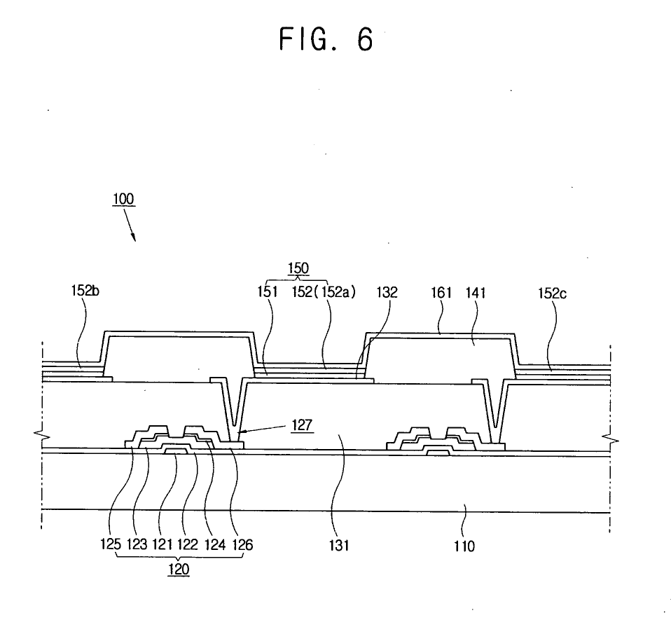

FIG. 6 is a sectional view of the display apparatus manufactured according to the present invention.

The display apparatus 100 according to the present invention includes a thin film transistor 120 formed on an insulating substrate 110, a pixel electrode 132 electrically connected to the thin film transistor 120, and an organic layer 150 formed on the pixel electrode 132.

In the particular embodiment, the thin film transistor 20 contains amorphous silicon but this is not a limitation of the invention. For example, in other embodiments, the thin film transistor may contain poly silicon.

In more detail, the display apparatus 100 manufactured according to the present invention is as follows.

A gate electrode 121 is formed on the insulating substrate 110 made of a dielectric material such as glass, quartz, ceramic, plastic or the like.

A gate insulating film 122 including silicon nitride (SiNx) or the like is formed on the insulating substrate 110 and the gate electrode 121. A semiconductor layer 123 including amorphous silicon and an ohmic contact layer 124 including n+ amorphous silicon hydride highly doped with an n-type dopant are formed in sequence on the gate insulating film 122 corresponding to the gate electrode 121. Here, the ohmic contact layer 124 is separated into two parts with respect to the gate electrode 121.

A source electrode 125 and a drain electrode 126 are formed on the ohmic contact layer 124 and the gate insulating layer 122. Further, the source electrode 125 and the drain electrode 126 are separated into two parts with respect to the gate electrode 121.

A passivation film 131 is formed on the source electrode 125, the drain electrode 126 and an upper part of the semiconductor layer 123 exposed between the source and drain electrodes 125 and 126. The passivation film 131 can include silicon nitride (SiNx) and/or an organic material. The passivation film 131 is formed with a contact hole 127 to expose the drain electrode 126.

A pixel electrode 132 is formed on the passivation film 131. The pixel electrode 132 functions as an anode and supplies holes to the emission layer 152. The pixel electrode 132 includes a transparent conductive material such as indium tin oxide (ITO), indium zinc oxide (IZO), etc., and is formed by a sputtering method. Here, the pixel electrode 132 is patterned to have an approximately rectangular shape in plan view.

A partition wall 141 is formed between the pixel electrodes 132. The partition wall 141 divides the pixel electrodes 32 and defines a pixel zone. Further, the partition wall 141 is formed on the thin film transistor 120 and the contact hole 127. Here, the partition wall 141 prevents the source and drain electrodes 125 and 126 of the thin film transistor 120 from being short-circuited with the common electrode 161. The partition wall 141 includes a photosensitive material such as an acrylic resin, a polyimide resin, etc., which has heat resistance and solvent resistance; or an inorganic material such as SiO₂ and TiO₂. In some embodiments, the partition wall 141 may have a double structure of an organic layer and an inorganic layer.

A hole injecting layer 151 and the organic emission layer 152 are formed on the pixel electrode 132.

The hole injecting layer 151 includes a poly thiophene derivative such as poly(3,4-ethylenedioxy thiophene)(PEDOT) or the like and polystyrene sulfonic acid (PSS).

The organic emission layer 152 includes a red emission layer 152a for red, a green emission layer 152b for green and a blue emission layer 152c for blue.

The organic emission layer 152 includes a poly fluorene derivative; a (poly)paraphenylenevinylene derivative; a polyphenylene derivative; polyvinylcarbazole; and poly thiophene. Further, these polymer materials can be used as being doped with a perylene pigment; a rothermine pigment; rubrene; perylene; 9,10-diphenylanthracene; tetraphenylbutadiene; Nile red; coumarine 6; Quinacridone, etc.

A hole from the pixel electrode 132 and an electron from the common electrode 161 are combined into an exciton in the organic emission layer 152, and light is emitted while the exciton is inactivated.

The common electrode 161 is provided on the partition wall 141 and the organic emission layer 152. The common electrode 161 functions as a cathode and supplies electrons to the organic emission layer 152. The common electrode 161 may include a calcium layer and an aluminum layer in a stacked configuration. The calcium layer having a relatively low work function is preferably disposed close to the organic emission layer 152.

Lithium fluoride enhances emission efficiency according to materials of the organic emission layer 152. To take advantage of this enhancement, a lithium fluoride layer may be formed between the organic emission layer 152 and the common electrode 161. When the common electrode 161 is made of an opaque material such as aluminum, silver or the like, light is emitted from the organic emission layer 152 toward the insulating substrate 110, which is called a bottom emission type.

Further, the display apparatus 100 can include an electron transfer layer (not shown) and an electron injecting layer (not shown) between the organic emission layer 152 and the common electrode 161. Also, the display apparatus 100 can include a passivation film (not shown) to protect the common electrode 161 and an encapsulating member (not shown) to prevent water and air from permeating into the organic layer 150. Here, the encapsulating member can include an encapsulating resin.

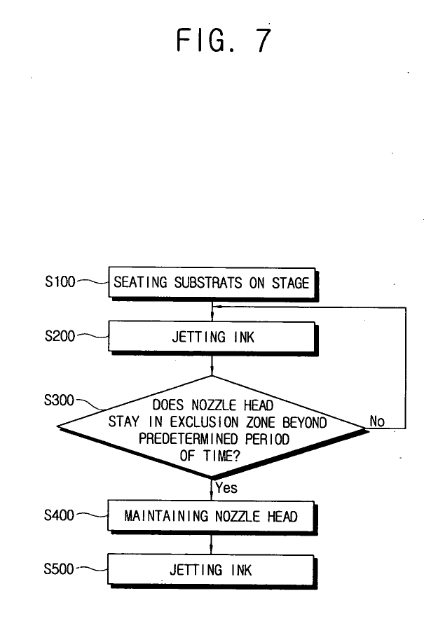

Below, a method of manufacturing the display apparatus according to the present invention will be described in reference to FIGS. 7 through 12B.

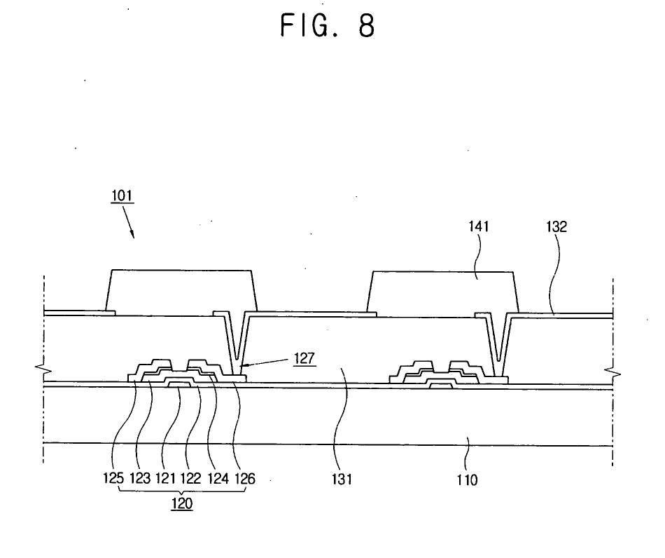

FIG. 7 is a flowchart of the inkjet method according to the present invention; and FIGS. 8, 9A, 9B, 9C, 10A, 10B, 11A, 11B, 12A and 12B illustrate a method of manufacturing the display apparatus according to the present invention.

First, referring to FIG. 8, a substrate 101 is manufactured. Here, the substrate 101 includes the thin film transistor 120, the pixel electrode 132 and the partition wall 141.

The thin film transistor 120 has an amorphous silicon channel, which can be manufactured by a well known method.

After forming the thin film transistor 120, the passivation film 131 is formed on the thin film transistor 120. When the passivation film 131 includes silicon nitride, it can be formed by a chemical vapor deposition (CVD) method. When the passivation film 131 includes an organic material, it can be formed by a spin coating method, a slit coating method, etc. Then, the passivation film 131 is patterned to form the contact hole 127 exposing the drain electrode 126. After forming the contact hole 127, the pixel electrode 132 is formed to be connected with the drain electrode 126 through the contact hole 127. Here, the pixel electrode 132 can be formed by patterning the ITO that is deposited by the sputtering method.

The partition wall 141 is formed by exposing and developing a photosensitive material coated on the pixel electrode 132.

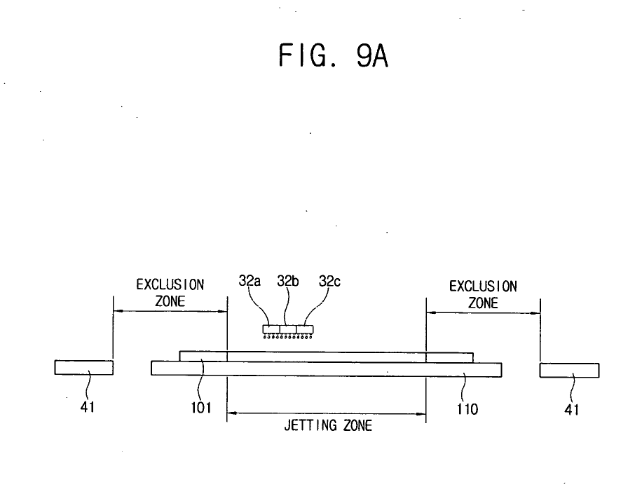

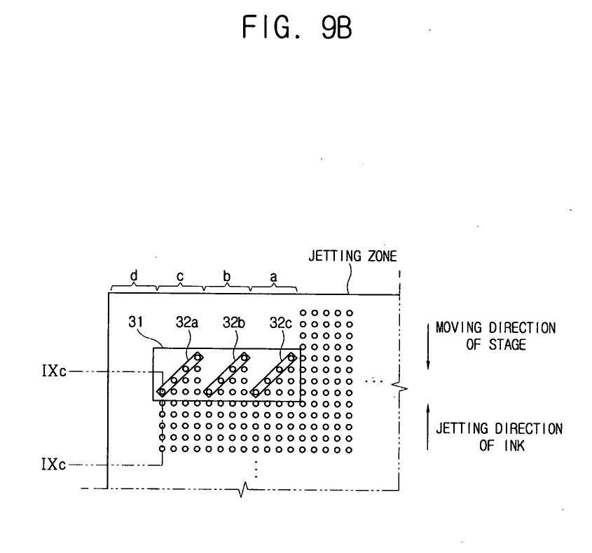

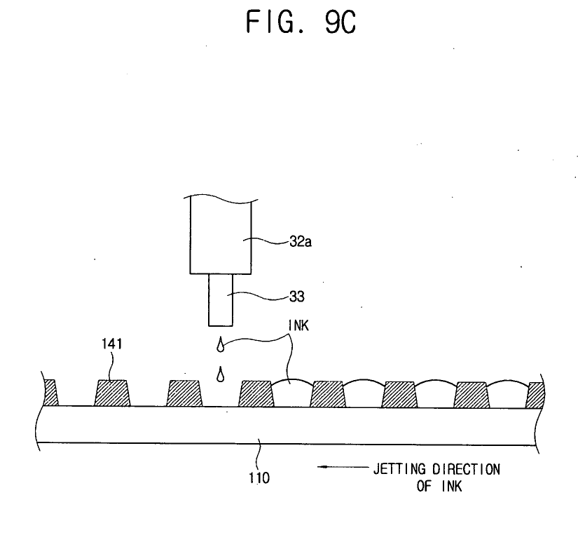

FIGS. 9A through 9C schematically illustrate the process of FIG. 7. At operation S100, the substrate 101 is placed on the stage 10. At operation S200, the ink is jetted on the substrate 101.

The ink includes a hole injecting material and a solvent, and is jetted onto the pixel electrode 132 exposed between the partition walls 141. In more detail, the ink includes the mixture of a poly thiophene derivative such as poly (3,4-ethylenedioxy thiophene)(PEDOT) and polystyrene sulfonic acid (PSS), and a solvent capable of dissolving the mixture. In this process, each of the sub ink feeders 35a, 35b and 35c supplies the same ink.

In the jetting zone, there are provided sub jetting zones a, b, c and d corresponding to the sub nozzle heads 32a, 32b and 32c, respectively.

In the state of FIGS. 9A and 9B, all nozzle heads 32 are placed within the jetting zone and release the ink. In this state, the nozzle head 32 does not blur the inkjet apparatus with the ink and the nozzle 33 does not clog.

Here, the nozzle head 32 is stationary, while the stage 10 moves in the second direction. Therefore, the ink is deposited from one side of the stage 10 to the other side.

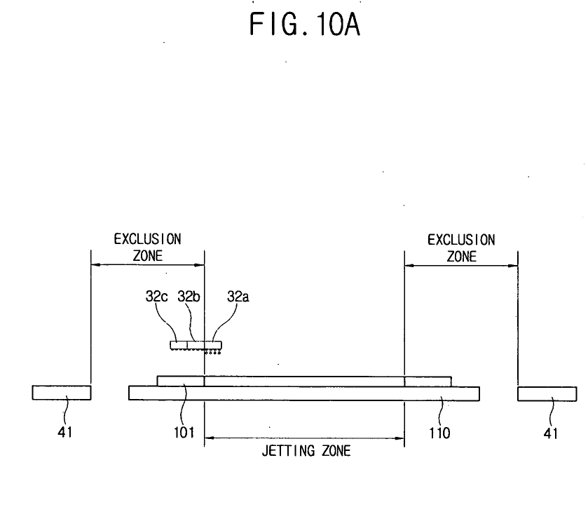

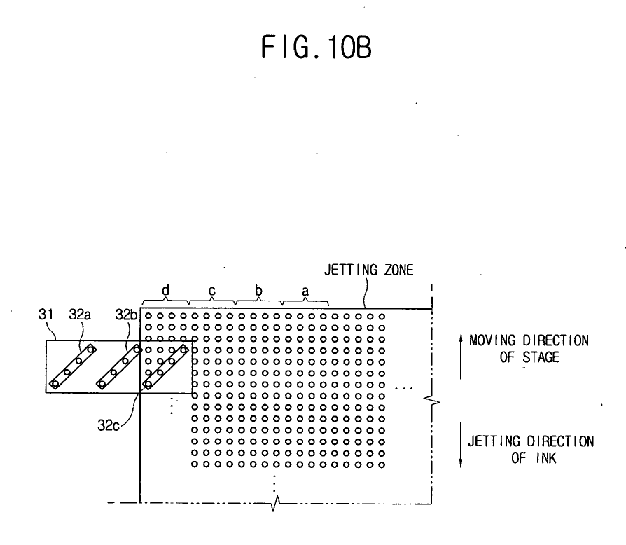

FIGS. 10A and 10B show the inkjet process being performed only in the leftmost sub jetting zone d. After the ink is deposited on the top part of the jetting zone (“top” being in reference to FIG. 10B), the nozzle head 32 moves left and the stage 10 moves upward (“left” and “upward” here are in reference to FIG. 10B). By repeating this, the ink is deposited from one side of the stage 10 to the other side.

Because the sub jetting zone d is covered by the sub nozzle head 32c in the state of FIGS. 10A and 10B, two left sub nozzle heads 32a and 32b are placed outside the jetting zone. When the sub nozzle heads 32a and 32b placed outside the jetting zone perform the jetting operation, the substrate 101 or the stage 10 may has ink in the exclusion zone where there should not be any ink. According to the present invention, the exclusion zone is set between the outside the jetting zone and the ink-receiver 41 so that the sub nozzle heads 32a and 32b stop the jetting operation. On the other hand, the sub nozzle head 32c placed within the jetting zone continues to jet out the ink to the corresponding sub jetting zone D.

That is, when the sub nozzle heads 32a and 32b are placed in the exclusion zone, the controller 51 controls the corresponding sub ink feeders 35a and 35b such that they do not supply any ink to the sub nozzle heads 32a and 32b. This way, ink is not deposited on the substrate 101 or the stage 10.

At operation S300, the controller 51 tracks the time when the sub nozzle heads 32a and 32b stay in the exclusion zone without jetting the ink, and determines whether the tracked time is longer than a predetermined period of time.

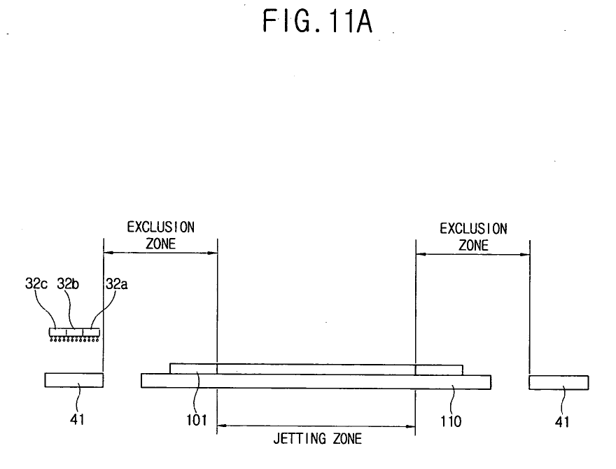

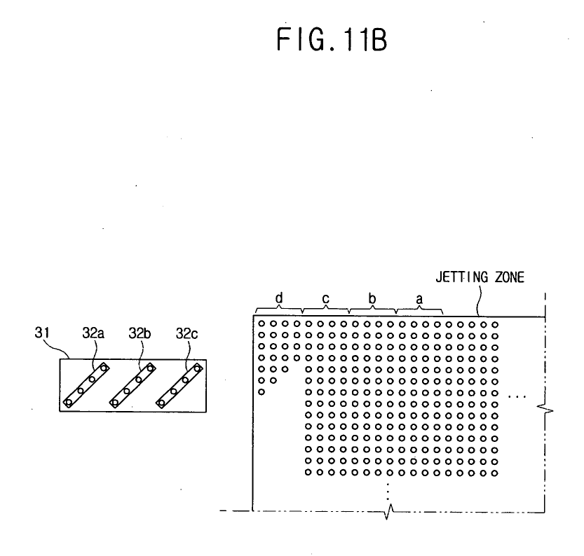

At operation S400, as shown in FIGS. 11A and 11B, when a predetermined period of time elapses with the sub nozzle heads 32a and 32b positioned in the exclusion zone, the controller 51 performs a maintenance operation on the sub nozzle heads 32a and 32b.

When the the sub nozzle heads 32a and 32b do not operate for more than a predetermined period of time, the nozzle 33 may become clogged. Therefore, the controller 51 performs a maintenance operation to prevent the sub nozzle heads 32a and 32b from becoming inoperative, such as by clogging. According to the present invention, the controller 51 controls the sub nozzle heads 32a and 32b to move to the left ink-receiver 41 and jet the ink. This way, the the sub nozzle heads 32a and 32b do not become clogged while they are placed in the exclusion zone and they are able to be operated as needed.

In this operation, the controller 51 controls the first driver 23 to place the head body 31 above the ink-receiver 41. Further, while the head body 31 moves, the controller 51 controls the sub nozzle head 32c to stop jetting the ink, and controls the sub nozzle heads 32a and 32b to jet the ink when the head body 31 is placed above the ink-receiver 41. After completing the maintenance, at operation S500, the sub nozzle head 32c returns to the sub jetting zone d and continues to jet the ink to the sub jetting zone d.

Through the foregoing operations, the jetting operation for forming the hole injecting layer 151 is completed. When the ink is dried, the hole injecting layer 151 is formed. The organic emission layer 152 is formed by a similar method as the hole injecting layer 151.

Then, the common electrode 161 is formed on the partition wall 141 and the organic emission layer 152, thereby completing the display apparatus 100 as shown in FIG. 6.

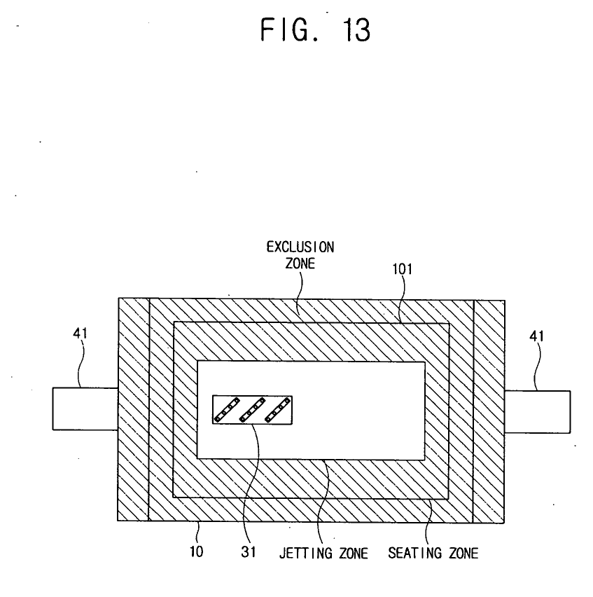

FIGS. 13 through 15 illustrate inkjet apparatuses according to second through fourth embodiments of the present invention, respectively.

Referring to FIG. 13, in the inkjet apparatus according to the second embodiment of the present invention, the exclusion zones are provided along all edges of the jetting zone. An advantage of having the exclusion zone surrounding the jetting zone is that deposition of ink in undesired areas will be avoided regardless of where the head body 31 is placed outside the jetting zone.

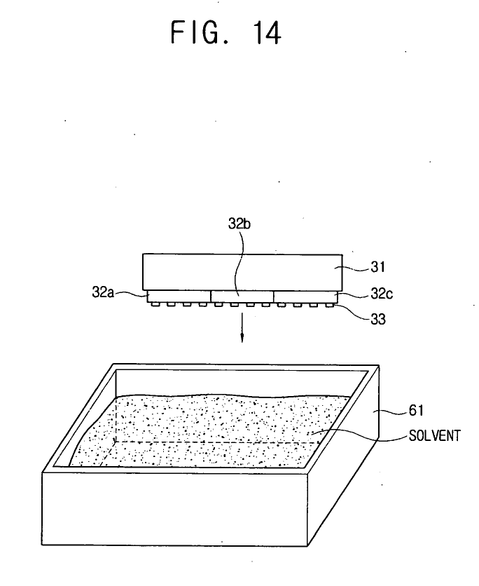

Referring to FIG. 14, in the inkjet apparatus according to the third embodiment of the present invention, there is provided a capping station 61 filled with a solvent. The capping station 61 can be either provided instead of the ink-receiver 41 or in addition to the ink-receiver 41. Further, the capping station 61 is preferably placed under the first screw 22, like the ink-receiver 41.

In the case where a predetermined period of time elapses with some of the sub nozzle heads 32a, 32b and 32c in the exclusion zone, the controller 51 places the head body 31 above the capping station 61 and immerses the nozzle 33 in the solvent of the capping station 61. The solvent penetrates into the nozzle 33, thereby preventing any clogging and maintaining the optimal performance level of the nozzle 33.

To perform the maintenance, the controller 51 controls the drivers 23 and 25 to adjust the position of the head body 31. If the capping station 61 is connected to a separate lifting unit that can adjust the position of the capping station 61, the controller 51 may control only the first driver 23 to adjust the position of the head body 31.

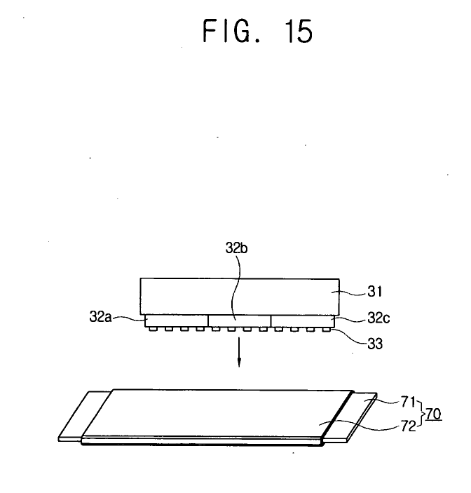

Referring to FIG. 15, in the inkjet apparatus according to the fourth embodiment of the present invention, there is provided a blotting stage 70 including a bar 71 and an absorber 72 wrapped around the bar 71. The blotting stage 70 can be provided instead of the ink-receiver 41 or in addition to the ink-receiver 41. The blotting stage 70 is preferably placed under the first screw 22, like the ink-receiver 41. The absorber 72 may comprise cloth capable of absorbing the ink well.

In the case where a predetermined period of time elapses with some of the sub nozzle heads 32a, 32b and 32c in the exclusion zone, the controller 51 places the head body 31 above the blotting stage 70 and contacts the nozzle 33 with the absorber 72 of the blotting stage 70. Thus, the ink in the nozzle 33 is absorbed by the absorber 72. As that the ink is continuously supplied to the nozzle 33, the performance level of the nozzle 33 is maintained (e.g., no clogging).

To perform the maintenance, the controller 51 controls the drivers 23 and 25 to adjust the position of the head body 31. If the blotting stage 70 is connected to a separate lifting unit such that the blotting stage 70 can be moved, the controller 51 may control only the first driver 23 to adjust the position of the head body 31.

The inkjet apparatus having the exclusion zone and the inkjet method using the same can be applied to manufacturing the substrate for various types of display apparatuses other than OLED.

For example, the present invention can be applied to manufacturing an organic thin film transistor substrate using an organic semiconductor as a semiconductor layer. The organic thin film transistor substrate can be applied to the OLED or an LCD.

The inkjet apparatus and the inkjet method according to the present invention can be applied to manufacturing a color filter substrate, e.g., to forming the alignment layer using polyimide or manufacturing a color filter layer of the color filter substrate.

As described above, the present invention provides an inkjet apparatus which can reduce blurred deposition of ink.

Further, the present invention provides an inkjet method which can reduce blurring of the boundary where ink is deposited.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An inkjet apparatus comprising:
a stage having a seating zone for supporting a substrate, a jetting zone, and an exclusion zone;
a nozzle head having a nozzle directed toward the stage;
an ink feeder supplying ink to the nozzle head;
a driver driving at least one of the nozzle head and the stage to move the nozzle head and the stage relative to each other; and
a controller controlling the ink feeder to supply ink to the nozzle head when the nozzle head is placed in the jetting zone and to stop the ink supply to the nozzle head when the nozzle head is placed in the exclusion zone.

2. The inkjet apparatus according to claim 1, wherein at least part of the exclusion zone extends outside the stage.

3. The inkjet apparatus according to claim 2, wherein the exclusion zone is formed at two ends of the jetting zone.

4. The inkjet apparatus according to claim 3, wherein the exclusion zone has a first part and a second part located across the seating zone from each other.

5. The inkjet apparatus according to claim 2, wherein the exclusion zone at least partially overlaps the seating zone.

6. The inkjet apparatus according to claim 5, wherein the exclusion zone is formed at two ends of the seating zone.

7. The inkjet apparatus according to claim 6, wherein the exclusion zone has a first part and a second part positioned across the seating zone from each other.

8. The inkjet apparatus according to claim 1, wherein the controller controls at least one of the driver and the ink feeder during a maintenance operation on the nozzle for preventing the nozzle head from clogging, wherein the maintenance operation is triggered by the nozzle head being in the exclusion zone for a predetermined period of time.

9. The inkjet apparatus according to claim 8, further comprising an ink-receiver located adjacent to the stage and accommodating the ink that is released from the nozzle,
wherein the controller controls the driver and the ink feeder to drive the nozzle head to be positioned above the ink-receiver during the maintenance operation.

10. The inkjet apparatus according to claim 8, further comprising a capping station located adjacent to the stage and filled with a solvent,
wherein the controller controls the driver to immerse the nozzle in the capping stage during the maintenance operation.

11. The inkjet apparatus according to claim 8, further comprising a blotting stage located adjacent to the stage and having an absorber to absorb the ink,
wherein the controller controls the driver to contact the nozzle with the absorber during the maintenance operation.

12. The inkjet apparatus according to claim 1, further comprising an ink-receiver located adjacent to the stage and accommodating the ink that is released from the nozzle, wherein the exclusion zone is adjacent to the ink-receiver.

13. The inkjet apparatus according to claim 1, wherein the driver comprises:
a first sub driver to move the nozzle head in a first direction; and
a second sub driver to move the stage in a second direction that is perpendicular to the first direction.

14. An inkjet method comprising:
providing a substrate on a stage that has a seating zone, a jetting zone, and an exclusion zone;
jetting ink toward the stage while a nozzle head having a nozzle and the stage are moved relatively to each other; and
stopping the nozzle head from jetting the ink when the nozzle head is placed in an exclusion zone.

15. The inkjet method according to claim 14, further comprising performing a maintenance operation to prevent the nozzle head from clogging when the nozzle head is in the exclusion zone for a predetermined period of time.

16. The inkjet method according to claim 15, wherein the maintenance operation comprises moving the nozzle head above an ink-receiver for accommodating the jetted ink.

17. The inkjet method according to claim 15, wherein the maintenance operation comprises immersing the nozzle in a solvent.

18. The inkjet method according to claim 15, wherein the maintenance operation comprises contacting the nozzle with an absorber located adjacent to the stage and absorbing the ink.
